(19) United States
(12) Patent Application Publication
(10) Pub. No.: US 2025/0378192 A1
(43) Pub. Date: Dec. 11, 2025

(54) METHOD AND SYSTEM TO MANAGE PERSONALLY IDENTIFIABLE INFORMATION IN A DOCUMENT

(71) Applicant: JP Morgan Chase Bank, N.A., New York, NY (US)

(72) Inventors: Min DAI, Allendale, NJ (US); Sharath SHETTY, Naperville, IL (US); Puja MITTAL, Princeton Junction, NJ (US); Donald CONTE, Hillsdale, NJ (US)

(73) Assignee: JP Morgan Chase Bank, N.A., New York, NY (US)

(21) Appl. No.: 18/740,358

(22) Filed: Jun. 11, 2024

(51) Int. Cl. G06F 21/62

(52) U.S. Cl. CPC G06F 21/6245

(57) ABSTRACT

There are provided methods and systems for retrieval and management of target information in one or more files. For example, there is provided a system that includes a processor and memory including instructions which, when executed by the processor, can cause the processor to perform certain operations. The operations can include receiving a file and categorizing the file into one or more components. The operations can further include extracting a machine-readable arrangement from the one or more components and detecting target information from the machine-readable arrangement. Further, the operations can include modifying the target information and assembling an output file including the modified target information.

### TECHNICAL FIELD

The present disclosure relates to methods and systems for managing personally identifiable information (PII) in one or more documents. Particularly, the methods and systems are based on artificial intelligence (AI) and/or large language models (LLM).

### BACKGROUND

The electronic transfer of documents containing sensitive information is unavoidable in modern enterprises. Businesses as well as government entities rely on Internet communications to receive and transfer files from and to customers or to other entities. While such communications can be encrypted to ensure security, there are other opportunities along the transfer chain where sensitive information may be accessed by unauthorized parties. For example, and not by limitation, sensitive information may be retrieved at a receiving party by an entity that does not have the requisite permission to access the sensitive information. As such, the information is compromised. The unauthorized entity may be adverse to the person to whom the information belongs, or simply, the person's right to privacy may have been violated even when the receiving party has no nefarious intent.

One approach is to remove sensitive information, especially if it is not needed for the transaction. There are commercial tools available to remove information from documents, but they have limited availability as well as limited functionality. For example, these commercial tools do not provide visualization and reconversion of a file to its original format after information removal. As such, existing tools are limited and do not provide the capability to process a large number of files consistently and rapidly.

### SUMMARY

The embodiments featured herein help solve or mitigate the above-noted issues as well as other issues known in the art. The embodiments provided herein offer real-time response without storing a document. For example, and not by limitation, the embodiments may provide temporary caching, managed by Python, to avoid storing documents containing sensitive information. Furthermore, the embodiments are configured to elevate data security using AI/LLM approaches.

For instance, in one embodiment, there is provided a PII detection and management module that can check, identify, and redact PII in documents that are being transferred from one party to another. The embodiments allow adherence to data protection requirements, mitigating risks and audit failures. With the exemplary PII detection and management module, one can protect against unauthorized access or transfer of sensitive information, ensuring compliance with privacy regulations. From a risk mitigation point of view, the embodiments can proactively identify and address potential security vulnerabilities, minimizing the risk of data breaches and protecting privacy.

One example embodiment provides a system including a processor and a memory including instructions, which when executed by the processor, can cause the processor to perform certain operations. The operations include receiving a file and categorizing the file into one or more components. The operations further include extracting a machine-readable arrangement from the one or more components and detecting target information from the machine-readable arrangement. Further, the operations include modifying the target information and assembling an output file including the modified target information.

In yet another exemplary embodiment, there is provided a method that resides as instructions on a non-transitory computer-readable medium where the instructions are configured to cause a processor executing them to perform certain operations consistent with target information retrieval and management in one or more files. The operations include receiving a file and categorizing the file into one or more components. The operations further include extracting a machine-readable arrangement from the one or more components and detecting target information from the machine-readable arrangement. Further, the operations include modifying the target information and assembling an output file including the modified target information.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an information detection and management system according to one or more aspects of the present disclosure.

FIG. 2 illustrates a process of an exemplary system according to one or more aspects of the present disclosure.

FIG. 3 illustrates a method according to one or more aspects of the present disclosure.

FIG. 4 illustrates a process of an exemplary system according to one or more aspects of the present disclosure.

FIG. 5 illustrates an example output of the process of FIG. 4 according to one or more aspects of the present disclosure.

FIG. 6A illustrates a process for PII detection using an LLM according to one or more aspects of the present disclosure.

FIG. 6B illustrates an example of the execution of the process of FIG. 6A according to one or more aspects of the present disclosure.

FIG. 7 illustrates a method according to one or more aspects of the present disclosure.

FIG. 8 illustrates a method according to one or more aspects of the present disclosure.

FIG. 9 illustrates an information detection and management system according to one more aspects of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

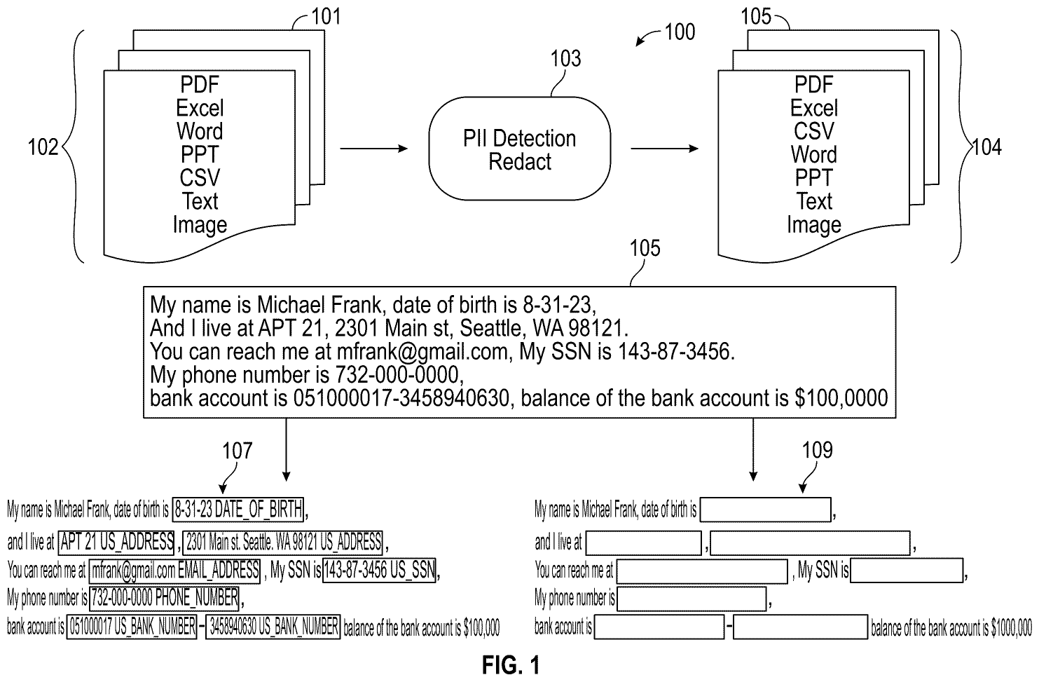

FIG. 1 illustrates an information retrieval and management system 100 according to an embodiment. The system 100 may be application-specific hardware configured by instructions to execute a method consisting of information retrieval and management. The system 100 may include an input section 102 that is configured to receive one or more files from a single source or a plurality of sources. The input section 102 may be a module or routine, or a sub-routine, that configures the system 100 to receive said file or files. The files may be different in their format and their contents. For example, and not by limitation, the system 100 may be configured to receive files 101 PDF, EXCEL, WORD, PPT, CSV, TEXT, or image files. In the latter case, images may be in one of a plurality of file formats, such as but not limited to, .TIFF, .PNG, or .JPG. These file types are exemplary and by no means an exhaustive list of file types that are receivable by the system 100.

Without loss of generality, the input section 102 may be configured to automatically detect which file type or which file types are being received. This may be achieved using file recognition techniques known in the art. For example, and not by limitation, a file type may be determined by the system 100 executing a file recognition routine consisting of parsing a received file for known information typically associated with a specific file type. In such an example, the information parsed may be metadata located in the file's header, wherein the metadata indicates the file type.

Upon receipt and/or after file type detection, the system 100 is configured to route the files received at the input section 102 to an information detection and management module 103. The module 103 may be configured to retrieve target information from the files. The target information may be a preset parameter, indicating to the module 103 that it must parse the files received from the input section to retrieve information that matches one or more categories associated with the preset parameter. In one non-limiting implementation of the embodiment, the target information may be PII.

The module 103 may be configured to redact or obstruct the target information from the files once the target information is flagged and retrieved from the files. Here, redacting or obstructing may include masking the target information to create an output file identical to its received counterpart except in parts where target information was flagged. In those parts, the target information may be blocked from view, for example, using a black bar that prevents a reader (machine or human) from reading what was originally there.

The module 103, or the system 100 at some other location, may include a module for detecting and returning a position of the target information within the file. To do so, the position detection module may set a reference addressing system for the file (e.g., the lines and columns may be numbered, or pixels may be numbered) and subsequently use that reference addressing system to return positions in the files that contain the desired information.

The text snippet 105 shows an example that may be contained in one file received at the input section 102. It reads: “My name is Michael Frank, date of birth is Aug. 31, 2023, and I live at Apt. 21, 2301 Main St., Seattle, WA, 98121. You can reach me at mfrank@gmail.com, My SSN is 143-87-3456. My phone number is 732-000-0000, bank account is 051000017-3458940630, and the balance of the bank account is $100, 000.” The text snippet 105 may be extracted from a file received at the input section 102 and parsed for target information. In the implementation where the target information is PII, the module 103 may be configured to retrieve any PII contained in the text snippet 105 and subsequently return a redacted version of the text snippet (i.e., text snippet 109), where the target information is redacted.

In the exemplary text snippet 109, the date of birth, address, email address, social security number (SSN), phone number, and bank account information may be redacted by placing a black box on that information at the locations in which they were retrieved in the text snippet 105. As such, the target information is modified (e.g., redacted) and subsequently placed in a copy of the file that is output via an output section 105 of the system 100.

In another embodiment, redaction or obstruction may be skipped after the target information is retrieved in the file. For instance, text snippet 107 shows an example where the target information (same as above in the case of text snippet 109) is flagged using keywords like (DATE_OF_BIRTH) for the birth date, US_ADDRESS for the address, EMAIL_ADDRESS for the email address, US_SSN for the SSN, PHONE_NUMBER for the phone number, and US_BANK_NUMBER for the bank account information. In such an implementation, the target information is merely flagged but not redacted. Without loss of generality, such a block, i.e., flagging the target information as shown in text snippet 109, may be achieved prior to redaction (text snippet 109). Lastly, without loss of generality, the example target information stated above (i.e., DATE_OF_BIRTH, US_ADDRESS, EMAIL_ADDRESS, US_SSN, US_BANK_NUMBER) is not limiting. In other words, any information may be deemed as being target information and flagged in one or more input files.

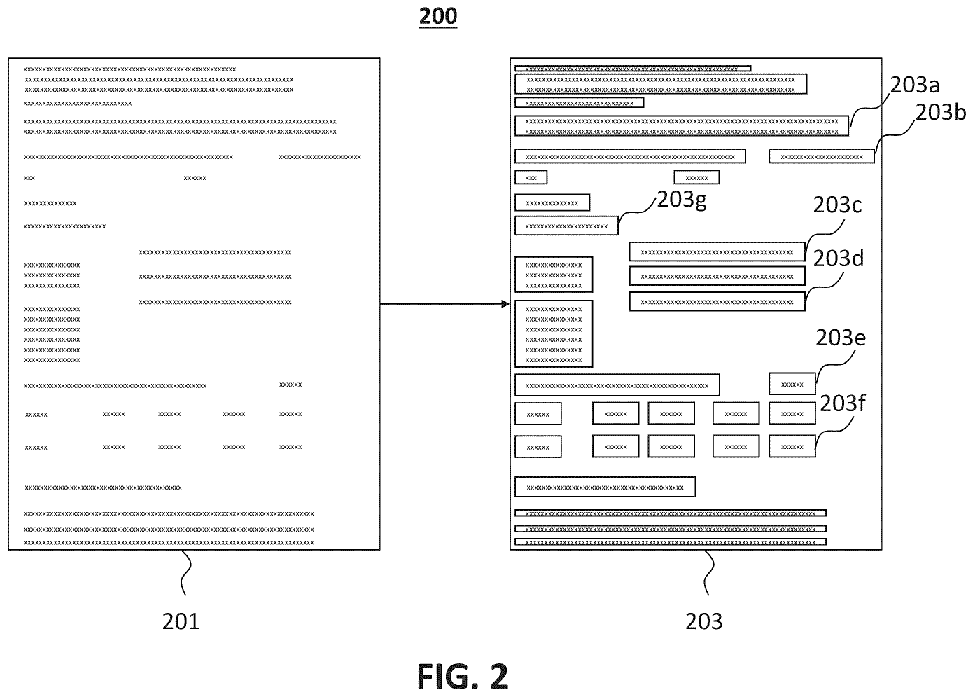

FIG. 2 illustrates process 200 of the exemplary system 100. For example, the files received at the input section 102 may include a file 201. The file 201 may include text information (denoted ‘xxxxxxxx’ in FIG. 2). It may also include images. Furthermore, the file 201 may include contents that extend beyond text or images. For instance, it may include tables, hyperlinks, watermarks, comments, widgets, etc. In such cases, the system 100 may also categorize these items and perform redaction or highlighting of target information in these categories as well.

Therefore, the system 100 may be configured to perform a layout analysis of an input file. In doing so, the system 100 may extract all text objects and their position information relative to a predetermined reference location in the file. Generally, the file may be parsed in a specific order, and the ranking in the order when the target information is reached may be returned as the position of the target information. The file 203 is an output of the process 200. It shows locations 203a-203g, delineated by the black boxes, where information is contained. The system 100 may output locations of the black boxes, which surround pieces of content from the file. As stated above, these contents may be categorized as text, images, widgets, etc. The system 100 may then proceed with the module 103 to determine which of the locations include the target information.

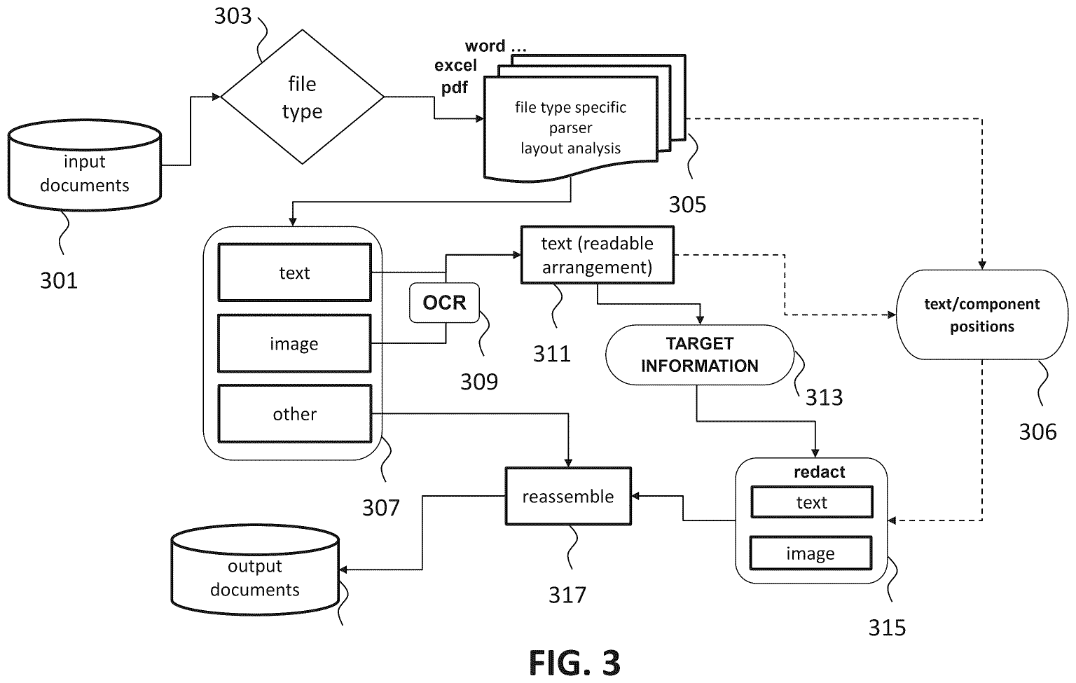

FIG. 3 illustrates method 300 according to one embodiment of the present disclosure. The method 300 may reside as instructions in a memory accessible to the system 100, and once fetched and executed by a processor of the system 100, they may cause the system 100 to perform operations consistent with information retrieval and management from one or more input files or documents. The method 300 may begin at block 301 wherein the system 100 receives one or more input documents and decides their file types at block 303. The method 300 may then execute a process similar to the process 200 to perform a layout analysis of the files (block 305). This analysis may be file-type specific, and further, may be specific to the various content types found in the files. In block 306, the method 300 may include causing the system to return component positions as discussed with reference to the process 200.

In block 307, the various contents of files may be categorized. Example categories include text and images, but other categories (e.g., widgets, hyperlinks, metadata) are also possible. At block 309, the method 300 includes executing an optical character recognition (OCR) routine to convert items from the various categories to machine-readable arrangements (block 311), which may be, without limitation, text data.

The method 300 may then include determining, via a target information detection module of the system 100, whether there is target information in the machine-readable arrangements at block 313. When target information is found, it may be redacted by covering the information at the location flagged, wherein the location is provided from results obtained at block 306. Redaction may be effected in text objects or image objects 315, or any other item categorized at block 307. The method 300 may then include reassembling 317, on a file-specific basis, wherein one or more reassembled files include redacted target information and are output by the system 100 at block 319.

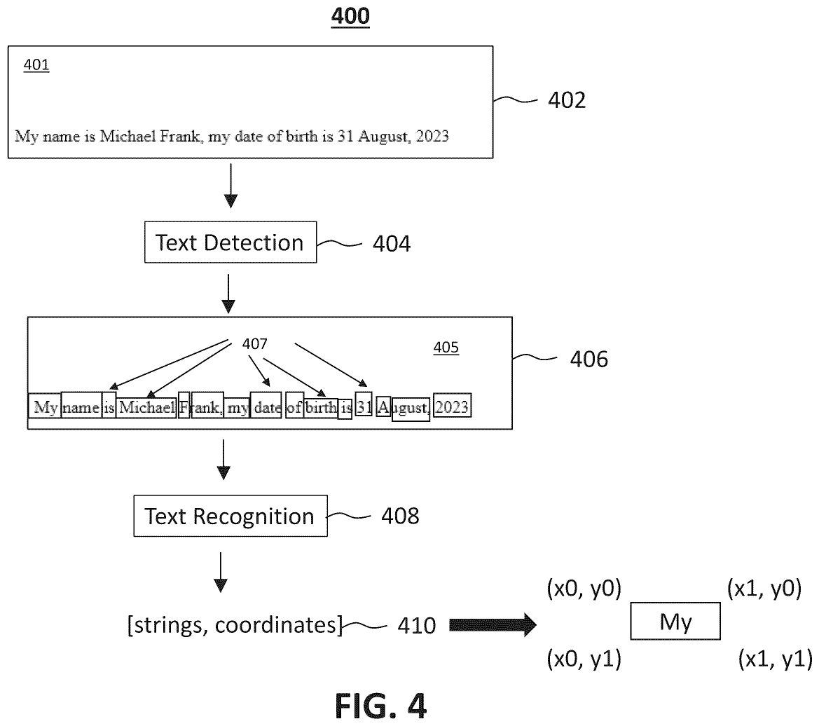

FIG. 4 illustrates a process 400 which may represent the core routine performed in the method 300. For example, the process 400 may include receiving an input image 401, of which a section is shown at block 402 of the process 400. The input image 401 may include PII. For instance, the input image may include the information “My name is Michael Frank, my date of birth is 31 Aug. 2023.” Upon receiving the image 401, the process 400 includes subjecting it to a text detection process 404 which can output a processed object 406. The processed object 406 is a representation of the input image 401, where different aspects of the input image 401 are indexed. For example, such indexing may include identifying regions in the image where there is text information and regions where there is no text.

The indexing may be achieved at the sub-word level, to detect the precise area occupied by each letter in the text information included in the input image 401. For example, the text detection process 404 may include distinguishing parts of the input 401 image where there is no text information (region 405) and regions 407 where there is textual information. The regions 407 precisely delineate the textual information on a per-letter basis. In other words, based on the size of the textual information, the process 400 may delineate a region 407 that is different in size from another region 407.

The process 400 then includes subjecting the processed object 406 to a text recognition process 408 which produces an output 410. The output 410 may include strings corresponding to the text information identified in the input image 401. The output 410 can further include image pixel box information (i.e., the regions 407). This information may include coordinates of the pixel boxes that surround the textual information. For example, the region 407 that includes the word “My” can be associated with vertices of the box returned by the text detection process 404. These coordinates may be outputted as (x0, y0), (x0, y1), (x1, y0), and (x1, y1). As such, in further steps, the regions corresponding to these coordinates may be redacted. Taken together, features of the process 400 perform OCR and in-image indexing operations.

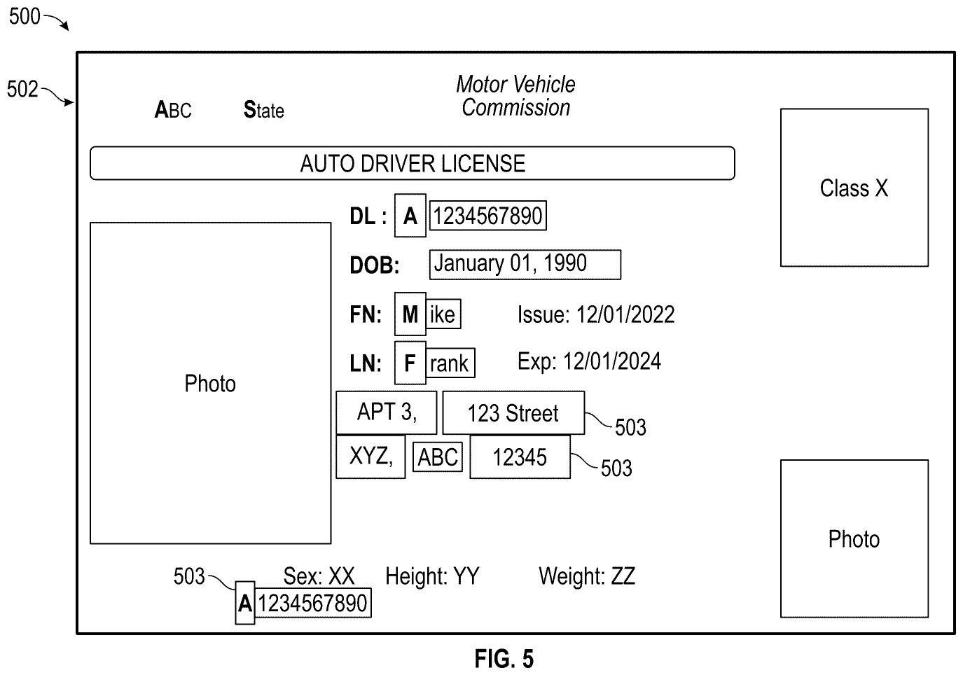

An example output 500 of the process 400 for a driver's license 502 is shown in FIG. 5. The driver's license 502 is fed to the process 400 as an image and the process 400 outputs a sub-word level detection of the textual information included in the image, precisely enclosing textual information of different sizes (regions 503, for example). The coordinates of the regions 407 are then available and ready for redaction.

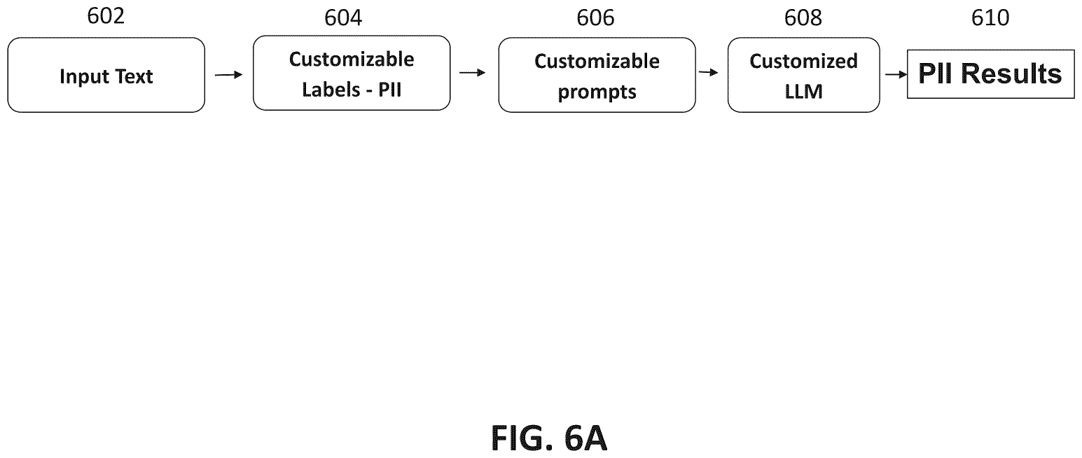

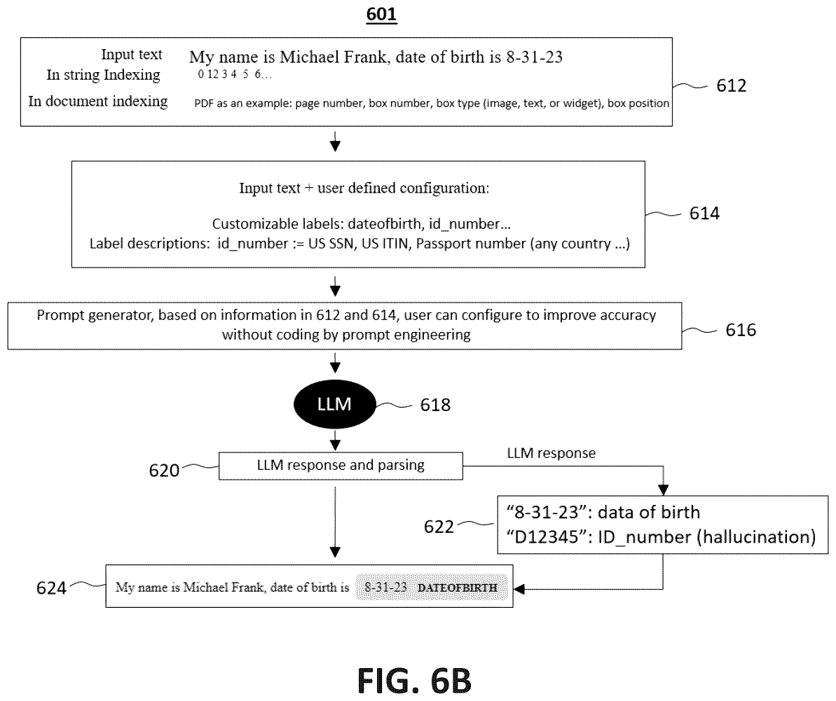

FIG. 6A illustrates a process 600 for detecting PII information based on an LLM. At block 602, the process 600 may receive input text extracted through a file using any one of the processes/methods previously described. The input text is received at block 602, and it is screened for customizable labels corresponding to PII at block 604. The process 600 may then issue customizable prompts at block 606, which are then fed to a customized LLM at block 608. The customizable LLM then outputs the PII results at block 610. The LLM can be customized in its quantization and architecture, making it deployable in different settings.

FIG. 6B shows an example 601 of the process 600 in execution. At block 612, the process 600 receives input data. The input data may include input text that has been detected and recognized using a process, such as the process 400. The input data can further include in-string indexing data, in-document indexing data, or in-image indexing data. At block 614, customized labels and their corresponding descriptions may be paired with the input data to generate prompts at block 616. At block 616, a user may configure the output prompts to improve accuracy without needing to code by prompt engineering.

The prompts are then fed to the LLM at block 618, which provides an output 624 at block 620. The LLM response may be structured according to the label, providing different classes of PII that have been found in the input at block 622. For instance, based on the LLM output the process 600 may find the position of “Aug. 31, 2023” in the original input text and redact or highlight that feature. Lastly, hallucinations have no impact since they cannot be found in the input text.

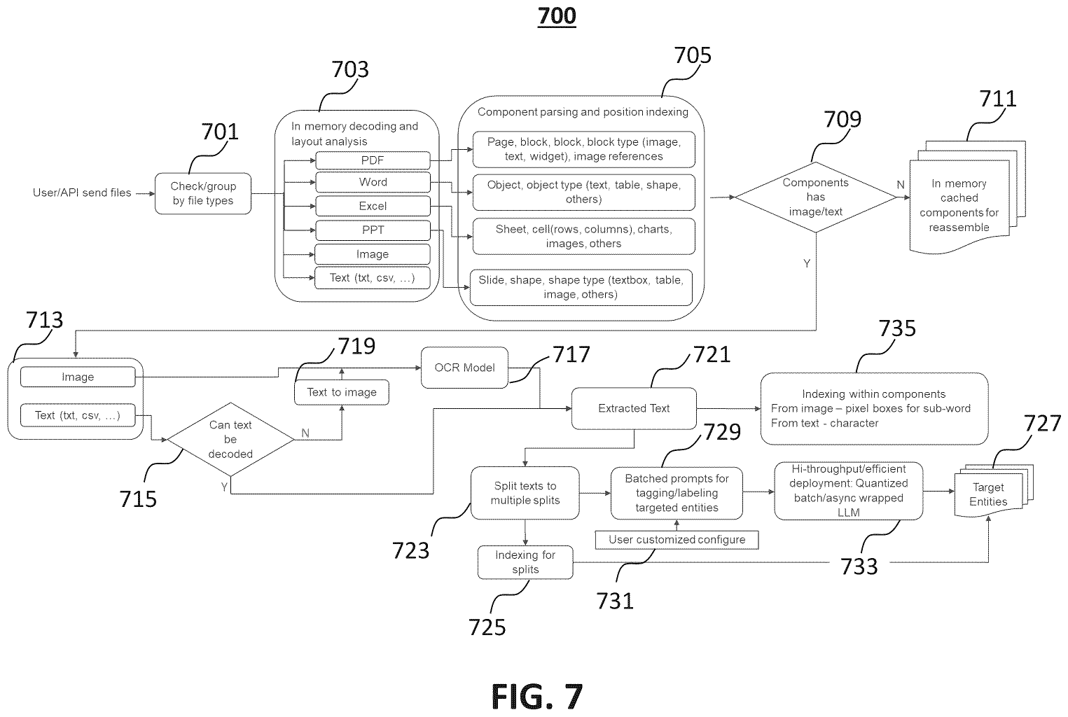

FIG. 7 illustrates a method 700 according to an embodiment. The method 700 may be executed by system 100, and it may be embodied as instructions fetchable and executable by the system 100. When executing the instructions, method 700 may cause the system 100 to perform operations consistent with target information retrieval and management in one or more input files. The method 700 can include receiving one or more files from a user. A user, as defined herein, may be a machine or a human causing a machine to send one or more files to the system (e.g., system 100) executing the method 700. This transfer may be done via an application programming interface (API), and it may be initiated at the request of the system executing the method 700 or by another party.

Upon receiving the files, the method 700 includes checking for the file types and grouping files according to the file types detected at block 701. At block 703, the method 700 includes performing in-memory decoding and layout analysis of the files, which may be one of several file types (e.g., PDF, WORD, EXCEL, etc.). At block 705, the method 700 can include parsing the files, organizing them into components, and indexing the positions of each component. For example, and not by limitation, component groupings may include page, block, block type (e.g., image, text, widget), and image references in the case of a PDF file.

In the case of a Word file, the component groupings may include object, or object type (e.g., table, text, shape, etc.). In the case of an Excel file, the component groupings may include sheets, cells (rows and columns), charts, images, etc. In the case of a PowerPoint file, the component groupings may include slide, shape, and shape type (e.g., text box, table, image, text, etc.). Generally, groupings are made according to file type and can differ from file to file.

At block 709, the method 700 may include determining whether the components have images or text. If no, the components are cached, and they are ready to reassemble at block 711 to output file(s) that are unchanged since no information was found therein. In yes, at block 709, the method 700 moves to block 713 where images and text are further categorized into distinct objects.

If the text in the text objects can be decoded directly 715 (i.e., they are already machine-readable), they are routed to an extraction module at block 721. If the text in the text objects cannot be decoded directly, the text objects are converted to images at block 719 and subsequently sent to an OCR model at block 717, at which point machine-readable text arrangements are obtained and extracted at block 721.

In the case of the image objects at block 713, they are routed directly to the OCR model at block 717, and machine-readable text arrangements are obtained at block 721. Following the results of block 721, at block 735, the arrangements are indexed within their respective components using constructs like pixel boxes and characters.

The method 700 may also include splitting extracted texts into multiple objects at block 723 and indexing the splits at block 725. Based on a customized configuration at block 731, the split text may be output as prompt, in batch, for tagging, labeling, and to provide other targeted entities at block 729. These labeled constructs may then be fed to an LLM at block 733 to train the LLM which may return target entities at block 727. The target entities at block 727, are the targeted information which can be, for example, PII.

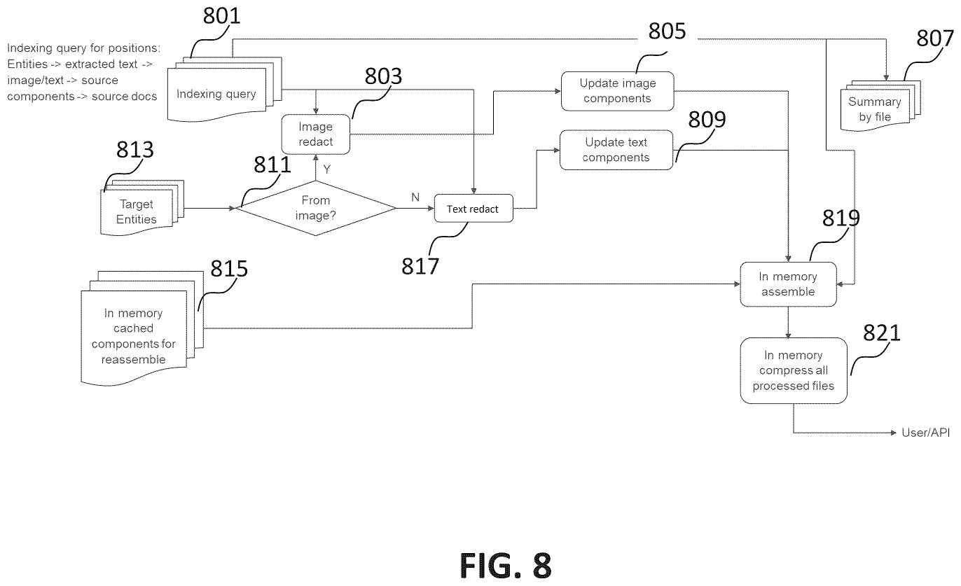

FIG. 8 illustrates a method 800 according to an embodiment. The method 800 may be executed by the system 100, and it may be embodied as instructions fetchable and executable by the system 100. When executing the instructions, the method 800 can cause the system 100 to perform operations consistent with target information retrieval and management in one or more input files. The source file may be received by the system 100 and process by the method 700, which may produce position information associated with the component groupings of each of the input files.

The method 800 can then, at block 801, index queries for positions from the component groupings, yield information about entities that are extracted, information about the source of images, and information about the source documents of the components in the grouping. Upon indexing the queries, the method 800 may include redacting the components in an image at block 803.

The method 800 may further update the image components at block 805, which is then reassembled in memory at block 819, compressed in memory, and output at block 821. In this case, the target information from the image was modified (i.e., redacted), creating a modified image in which the target information is neither human nor machine-readable. Indexed queries can be routed directly to text redaction at block 817. Components may be updated at block 809 with the redacted text, subsequently assembled at block 819, and output at block 821. Furthermore, indexing queries may be summarized in memory on a per-file basis at block 807.

Target entities output by the method 700 may also be processed at block 813 by the method 800. At block 811, if the target entities were from an image, they are processed by the method 800 as described above relative to blocks 803-821. Otherwise, the target entity is a text object, and it is processed directly at block 817. Components may be updated at block 809 with the redacted text, subsequently assembled at block 819, and output at block 821. At block 815, cached components from the method 700 may be routed to assembly at block 819 for combination with redacted information and output. The redacted files may be output to a user or an API.

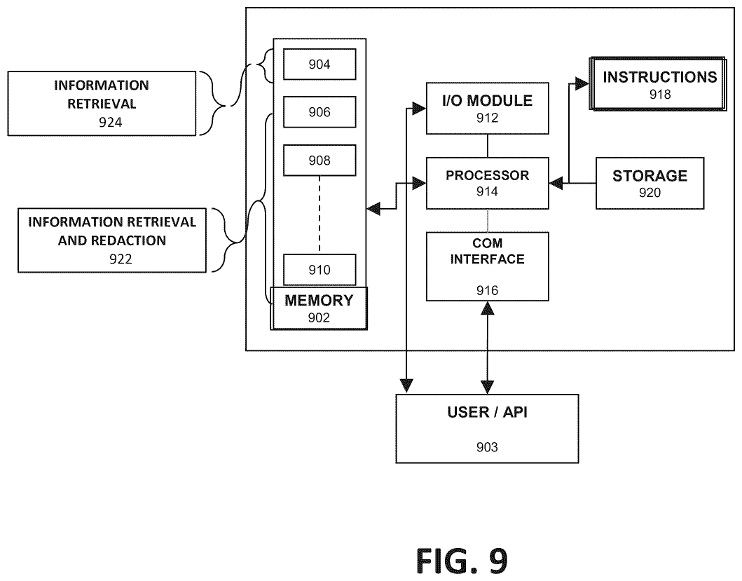

FIG. 9 describes an exemplary system 900 configurable to execute the various methods and processes described above. In the system 900, each of the various methods described herein, such as the methods 300, 700, and 800, as well as their processes and models (e.g., the processes 200 and 400 or the models 400, 500, and 600) may be embodied as instructions. These instructions may cause the system 900 to perform operations consistent with information retrieval and management from one or more files.

For example, the various methods may be embodied as instructions residing in a non-transitory component such as a memory or a storage device associated with the system 900. That is, the structure of the system 900 is imparted by the methods described herein in the form of the instructions.

The system 900 may be application-specific hardware, software, and firmware implementation (or a combination thereof) configured to execute the exemplary methods described herein. The system 900 may also represent a structural and application-specific implementation of the other exemplary systems described herein (e.g., the system 100). The system 900 can include a processor 914 configured to execute one or more, or all of the blocks of the exemplary methods described previously.

The processor 914 can have a specific structure imparted thereto by instructions stored in a memory 902 and/or by instructions 914 fetchable by the processor 914 from a storage medium 920. The storage medium 920 may be co-located with the system 900 as shown, or it can be remote and communicatively coupled to the system 900. Such communications may be encrypted.

The system 900 may be a stand-alone programmable system, or a programmable module included in a larger system. For example, the system 900 can be included as part of a larger system configured for information retrieval and management from a plurality of widely disparate sources. Also, the system 900 may include one or more hardware and/or software components configured to fetch, decode, execute, store, analyze, distribute, evaluate, and/or categorize information.

The processor 914 may include one or more processing devices or cores (not shown). In some embodiments, the processor 914 may be a plurality of processors, each having either one or more processing cores. The processor 914 can execute instructions fetched from the memory 902, i.e., from one of memory modules 904, 906, 908, or 910. Alternatively, the instructions can be fetched from the storage medium 920 or from a remote device connected to the system 900 via a communication interface 916. An input/output (I/O) module 912 may be configured for additional communications to or from remote systems or to a user interface 903. The user interface 903 may be a user terminal or an API, from which the processor 914 may receive a set of instructions configured to initiate one or more operations consistent with target information retrieval and management. Such additional communications may be facilitated by a communications interface 916.

Without loss of generality, the storage medium 920 and/or the memory 902 can include a volatile or non-volatile, magnetic, semiconductor, tape, optical, removable, non-removable, read-only, random-access, or any type of non-transitory computer-readable computer medium.

The storage medium 920 and/or the memory 902 may also include programs and/or other information usable by processor 914, such as instructions. The instructions enable the processor 914 to perform operations consistent with target information retrieval and management. Furthermore, the storage medium 920 can be configured to log data processed, recorded, or collected during the operation of the system 900.

The data may be time-stamped, location-stamped, cataloged, indexed, encrypted, and/or organized in a variety of ways consistent with data storage practice. By way of example, the memory modules 904-910 can form instructions that embody a method for retrieval and management of target information in one or more files.

In other words, the memory modules 904-910 may form a target information retrieval and management routine 922 that can cause the processor 914 to perform certain operations upon execution. For example, the operations may include receiving a file and categorizing the file into one or more components. The operations may further include extracting a machine-readable arrangement from the components and detecting target information from the machine-readable arrangement. Further, the operations may include modifying the target information and assembling an output file including the modified target information.

The operations may further include detecting a file type of the file, and detecting the target information may include executing an OCR module. Furthermore, detecting the target information may include the processor executing an AI-based module, and further, the AI-based module may include an LLM. Further, the operations may include obstructing a portion of a text component in the target information. The operations may also include obstructing a portion of an image component in the target information. The target information may be PII. Moreover, the operations may further include returning position information, and more particularly, the operations may include returning a position of the target information in the file.

Turning now to several general embodiments, descriptions are provided for an exemplary system, an exemplary method, and an exemplary computer-readable medium product. The exemplary system may include a processor and a memory including instructions, which when executed by the processor, can cause the processor to perform certain operations consistent with target information retrieval and management in one or more files. The operations may include receiving a file and categorizing the file into one or more components. The operations may further include extracting a machine-readable arrangement from the components and detecting target information from the machine-readable arrangement. Further, the operations may include modifying the target information and assembling an output file including the modified target information.

In the exemplary system, the operations may further include detecting a file type of the file, and detecting the target information may include executing an OCR module. Furthermore, detecting the target information may include the processor executing an AI-based module, and further, the AI-based module may include an LLM. Further, the operations may include obstructing a portion of a text component in the target information. The operations may include obstructing a portion of an image component in the target information. The target information may be personally identifiable information. Moreover, the operations may further include returning position information, and more particularly, the operations may include returning a position of the target information in the file.

The exemplary non-transitory computer-readable medium may include instructions configured to cause a processor configured to fetch and execute the instructions to perform certain operations consistent with target information retrieval and management in one or more files. The operations include receiving a file and categorizing the file into one or more components. The operations further include extracting a machine-readable arrangement from the one or more components and detecting target information from the machine-readable arrangement. Further, the operations include modifying the target information and assembling an output file including the modified target information.

In the exemplary non-transitory computer-readable medium, the operations may further include detecting a file type of the file, and detecting the target information may include executing an OCR module. Furthermore, detecting the target information may include the processor executing an AI-based model, and further, the AI-based model may include an LLM. Further, the operations may include obstructing a portion of a text component in the target information. The operations may also include obstructing a portion of an image component in the target information. The target information may be personally identifiable information. Moreover, the operations may further include returning position information, and more particularly, the operations may include returning a position of the target information in the file.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A system, comprising:
a processor;
a memory including instructions, which when executed, cause the processor to perform operations including:
receiving a file;
categorizing contents of the file into one or more components;
extracting a machine-readable arrangement from the one or more components;
detecting target information from the machine-readable arrangement;
modifying the target information; and
assembling an output file including the modified target information.

2. The system of claim 1, wherein the operations further include detecting a file type of the file.

3. The system of claim 1, wherein detecting the target information includes executing, by the processor, an optical characterization (OCR) module.

4. The system of claim 1, wherein detecting the target information includes executing, by the processor, an artificial intelligence (AI)-based module.

5. The system of claim 4, wherein the AI-based module is a large language model (LLM).

6. The system of claim 1, wherein the operations further include obstructing a portion of a text component in the target information.

7. The system of claim 1, wherein the operations further including obstructing a portion of an image component in the target information.

8. The system of claim 1, wherein the target information is personally identifiable information (PII).

9. The system of claim 1, wherein the operations further include returning position information.

10. The system of claim 9, further including returning a position of the target information in the file.

11. A method, residing as instructions on a non-transitory computer-readable medium, the instructions configured to cause a processor to perform operations comprising:
categorizing contents of a file into one or more components;
extracting a machine-readable arrangement from the one or more components;
detecting target information from the machine-readable arrangement;
modifying the target information; and
assembling an output file including the modified target information.

12. The method of claim 11, further including detecting a file type of the file.

13. The method of claim 11, wherein the detecting is based on artificial intelligence (AI)-based model.

14. The method of claim 13, wherein the AI-based model is a large language model (LLM).

15. The method of claim 11, wherein the machine-readable arrangement includes at least one of a picture and a portion of text.

16. The method of claim 11, further including obstructing a portion of the machine-readable arrangement.

17. A non-transitory computer-readable medium including instructions configured to cause a processor to perform operations comprising:
categorizing contents of a file into one or more components;
extracting a machine-readable arrangement from the one or more components;
detecting target information from the machine-readable arrangement;
modifying the target information; and
assembling an output file including the modified target information.

18. The non-transitory computer-readable medium of claim 17, wherein the operations further include detecting a file type of the file.

19. The non-transitory computer-readable medium of claim 17, wherein the extracting is based on an artificial intelligence (AI)-based model.

20. The non-transitory computer-readable medium of claim 18, wherein the AI-based model is a large language model (LLM).
